(19) United States
(12) Patent Application Publication
(10) Pub. No.: US 2008/0173836 A1
(43) Pub. Date: Jul. 24, 2008

(54) EASY-CONTROL VALVE

(76) Inventor: Shy-Shiun Chern, Anaheim, CA (US)

Correspondence Address: Chern, Shy-Shiun, 470 S. Sleepy Meadow Lane, Anaheim, CA, 92807, US

(21) Appl. No.: 11/855,264

(22) Filed: Sep. 14, 2007

Related U.S. Application Data
(60) Provisional application No. 60/881,661, filed on Jan. 22, 2007.

(51) Int. Cl. F16K 31/02

(52) U.S. Cl. 251/129.1; 137/487.5; 251/282

(57) ABSTRACT

In a Valve, grid-patterned, fixed wall(s) and movable gate plate/plug are built in the hub to control the conduction area. Adjustable spring is applied to push the gate/plug firmly against the fixed wall(s). The structure alteration reduces the travel length required to switch the valve between open and closed states. Since the open/close state is self-sustaining at its last switched state due to friction, no holding energy is required in the actuator. Consequently, a small linear operation solenoid can be used in impulse mode to operate the valve. Due to its low cost, separate solenoids are used to respectively pull open and close the valve in lieu of applying an auto-direction-conversion mechanism. A bimetallic strip contact in series with a resister, packaged together in a thermal isolating tube, is used to prevent the low-duty solenoid from excessive stress-time.

### CROSS REFERENCE TO RELATED APPLICATION

This application claims priority of U.S. Provisional Patent Application No. 60/881,661 filed on Jan. 22, 2007.

### BACKGROUND OF THE INVENTION

1. Field of the Invention

This invention relates to a gas safety valve, more specifically it relates to a valve, which helps the realization of low cost home gas safety systems so that home safety systems can be more affordable and widely utilized.

2. Description of the Related Art

Gas has become an item closely affecting our daily life. Due to its toxic and combustible nature, precaution is a necessity in all types of gas application.

For self confined systems, such as a gas central air heater or a gas water heater, proper safety devices are incorporated in the appliances. The key safety component is a sophisticated gas valve, which is expensive, application specific, very fragile and requires physical protection if it is used as a standalone device.

For non-self-confined systems, such as the gas burners on stovetops or for unexpected appliance failures, the ultimate safety provision for all these situations relies solely on the caution and alertness of the user/owner. On a long-term basis, this is definitely an inherent deficiency for gas safety in today's busy life, particularly for families with some very senior person and/or young child.

A number of attempts have been made to restrict the access of a child to the stove using different “lockout” mechanisms. Because of the discrepancy in the operation formats between a conventional gas valve and all available driving devices, no affordable, practical/all-weather, device has been found to automatically shut off the gas prior to situations go out of control.

One device partially meets this goal is a solenoid valve. Unfortunately this valve is not only expensive but it also has features that are unsuitable for safety devices: (1) It either has a smaller conduction cross-section than the valve rated size or it needs to be driven by a much larger solenoid; and more importantly, (2) it is in either normally close (NC) or normally open (NO) state and needs to remain energized to hold the valve in the opposite state.

### SUMMARY OF INVENTION

The object of this invention is to provide a simple, robust, low cost, easy to control valve useful for the realization of low cost home gas safety systems. The Ease Control (EC) Valve comprises:

a shortened switching length (SSL) valve of various types and

two separate, high pull force amplitude, short duty time, impulse solenoids, each solenoid is protected by a delayed recovery, thermal activated circuit breaker.

Since a conventional gas valve cannot be conveniently, thus economically, integrated with a low cost electrical actuator, we therefore will reform its characteristic. A conventional solenoid valve is doing so in a wrong way by reducing the plunger diameter of the valve to achieve a compromised control automation, which severely jeopardizes the properties of the valve. Notice that the workable stroke length and the initial deliverable force of a given solenoid act in inverse proportion. Therefore, this invention focuses on the following instead: (1) shortening the required switching length, (2) preserving the open/close state self-holding property of a conventional gas valve and (3) creating a circuit protection device. It should be emphasized that this invention is based on the existing valve fabrication process including the use of seal/lubrication liners. Feature (1) eliminates the discrepancy in the operation formats between valve and actuator. Feature (2) avoids the need for the solenoid to stay energized, allowing the use of a solenoid in the impulse mode to deliver a much larger pull force impulse for a short duration from a small solenoid. Feature (3) is then created to protect the impulse type solenoids. It conditions a bimetallic switch to result in long recovery delay so that it prevents the solenoid from being stressed overtime. The required switching length of a valve is shortened as follows such that a low cost solenoid can effectively drive it.

For a gate type conventional valve, the hub, in the middle portion of the valve, includes a pipe shaped cross-section region and a housing perpendicularly off the valve conduction path to hold the retreated gate plate when the valve is fully opened. The gate plate is sandwiched between the parallel housing walls, called front and rear seal plates. The seal plates in the pipe shaped region appear as rings grew on the inner “pipe” wall. Ideally, the seal plates and the gate plate should be perfectly parallel and gas tight fit, which is more costly to fabricate. The gate plate of a low cost gate valve is usually tapered, and positive seal between the gate and the seal plates is only achieved at the fully closed state. In all other gate states, partially or fully opened, no seal is effective between these plates; therefore the seal to the ambient is only held at the feed through site of the gate driven rod. This compromise jeopardizes the desirability for the valve to handle hazardous gas. In this invention, two measures are taken to rectify this shortcoming and to achieve our goal. First, the front seal plate in the pipe cross-section region is changed from a ring shape to a solid wall having grid pattern built on it. Second, the rear seal plate is otherwise identical to the front seal plate except for that it is a detachable plate, framed in the hub. This rear seal plate has a single-direction freedom to be pushed against the gate plate toward the front seal plate, by a spring load. The spring load enhances the seal along the contact surface between the front seal and the gate plates. Furthermore it also gives the gate assembly the ability to auto-adjust its fitness during the gate sliding motion. The hub end cap provides ultimate seal from the ambient for the valve. A hubcap consolidates multiple functions: seal cap of the valve, mounting plate of the solenoid and finally the solenoid plunger housing. In this case, the seal at the gate plate driving-rod feed-through is only one of the seal layers and does not play the critical role of a sole seal. An identical grid pattern is also built on the gate plate. The grid pattern is having its slots running perpendicular to the gate plate switching direction. When moving the gate for a distance equal to half the cycle of the grid pattern, the gate assembly changes from having their slots lined up (open state) to completely blocked (close state). This displacement of the gate plate is the switching length, which is greatly shortened from that of a conventional valve.

For a ball type conventional gas valve, the hub includes a ball seat socket and a rotate-able ball. The portion of the socket wall that could block the valve conduction is mostly empty, reducing to a ring; and a single, big, straight hole runs through the ball center perpendicular to the rotation axis. In this invention, hub structure changes, in the same principles that applied to the gate valve, are implemented. Basically, it involves adding grid-patterned walls. For performance optimization, the ball shape is replaced with a tapered cylindrical plug shape and spring is loaded from the top of the plug under the hub top cap.

### BRIEF DESCRIPTION OF DRAWINGS

Other features and advantages of the present invention will become apparent from the following detailed description of the preferred embodiments, which is to be taken in conjunction with the accompanying drawings.

FIG. 1 is the schematic sectional view of a preferred embodiment of the gate-type EC Valve 1 showing with system accessories connected, through dash lines on the right.

FIG. 2 is the schematic sectional view of the SSL gate Valve 21 shown in FIG. 1.

FIG. 3 is a schematic end view showing the retention wall and the spring and the spring holder in valve 21 viewed along line III-III of FIG. 2.

FIG. 4 is a schematic end view showing the front seal plate of valve 21 viewed along line IV-IV of FIG. 2.

FIG. 5 is a schematic end view showing the gate plate of valve 21 viewed along line V-V of FIG. 2.

FIG. 6 is a schematic end view showing the rear seal plate of valve 21 viewed along line VI-VI of FIG. 2.

FIG. 7 is a schematic bottom view showing the top hub edge closure flange of valve 21 viewed along line VII-VII of FIG. 2.

FIG. 8 is a schematic bottom view showing the bottom hub closure wall of valve 21 viewed along line VIII-VIII of FIG. 2.

FIG. 9 is a schematic top view showing the top connection flange of valve 21 viewed along line IX-IX of FIG. 2.

FIG. 10 is the schematic sectional view of the multiple-function hubcap for valve 21.

FIG. 11 is the schematic sectional view of a preferred embodiment of the ball type EC Valve, showing the detail of SSL Valve 22 and the solenoid linkage bar 3012 on the cross-section. More detail of the solenoid is shown in FIG. 14.

FIG. 12 is a schematic top view showing the plug structure of the SSL Valve 22 viewed along line XII-XII of FIG. 11 when the plug 223 is in the open position.

FIG. 13 is a repetition of FIG. 12 when the plug 223 has rotated 18 degree to the closed position.

FIG. 14 is the schematic sectional view of the same preferred embodiment of the ball type EC Valve shown in FIG. 11 viewed along line XIV-XIV of FIG. 11. This sectional view reveals mostly the detail of solenoids.

FIG. 15 is the schematic circuit diagram and the side view cross-section of a preferred embodiment of the delayed-restoring automatic circuit breaker.

FIG. 16 is the top sectional view of FIG. 15.

### DETAILED DESCRIPTION OF THE PREFERRED EMBODIMENTS

It should be noted that like elements are denoted by the same reference numbers throughout the description. It should also be understood that the invention should not be limited to these embodiments. Although numerical values (such as mm, degrees, pounds, volts, amperes, ohms and turns) are used, they are used to illustrate the approximate values of preferred embodiments and not to limit the invention to the specific values. Illustration of design may be pushed to its extreme; however, principles presented remain valid in case of trade off adjustments for (tooling) cost minimization.

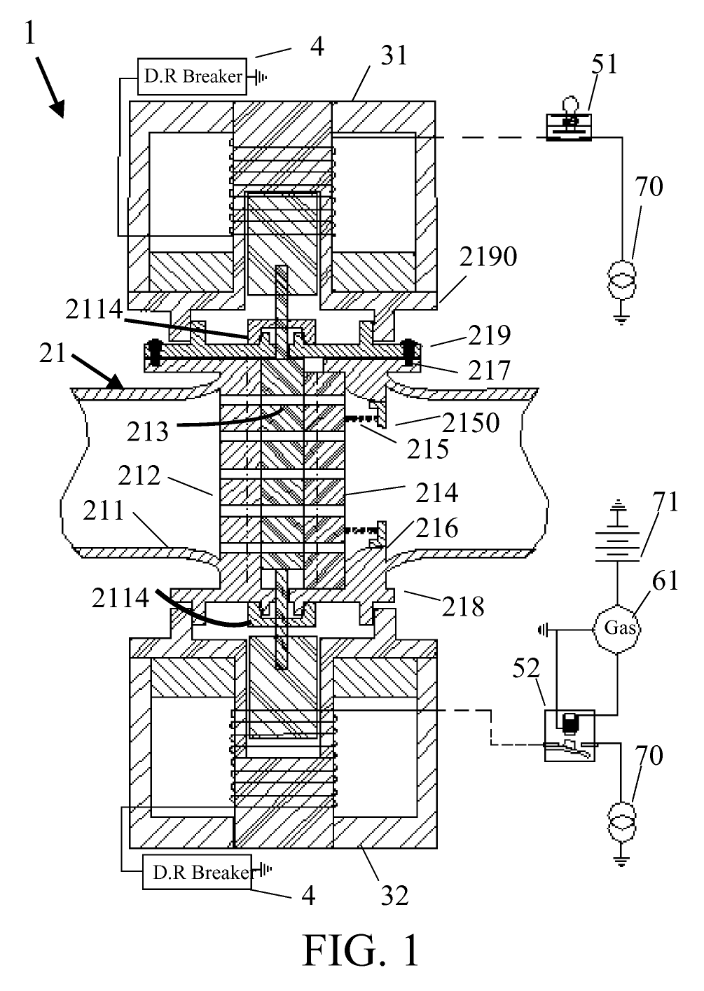

One embodiment of the invention is directed to a gate type EC valve that is shown as item 1 in FIG. 1. Item 1 comprises a SSL valve 21, and two solenoids 31 (to open) & 32 (to Close) along with their protection circuits, delayed recovery automatic circuit breakers 4. The EC valve is to be inserted between the gas source pipe and a gas appliance, such as a stove. FIG. 1 illustrates a range safety system, using item 1 along with low cost, commercially available parts. These parts include a doorbell type reset-push-button 51, an (NO, Single Pole Single Throw/SPST, 5-volt DC, 1 Amp.) interface relay 52, a (5-volt DC) gas sensor 61, AC power supply 70 and DC source 71.

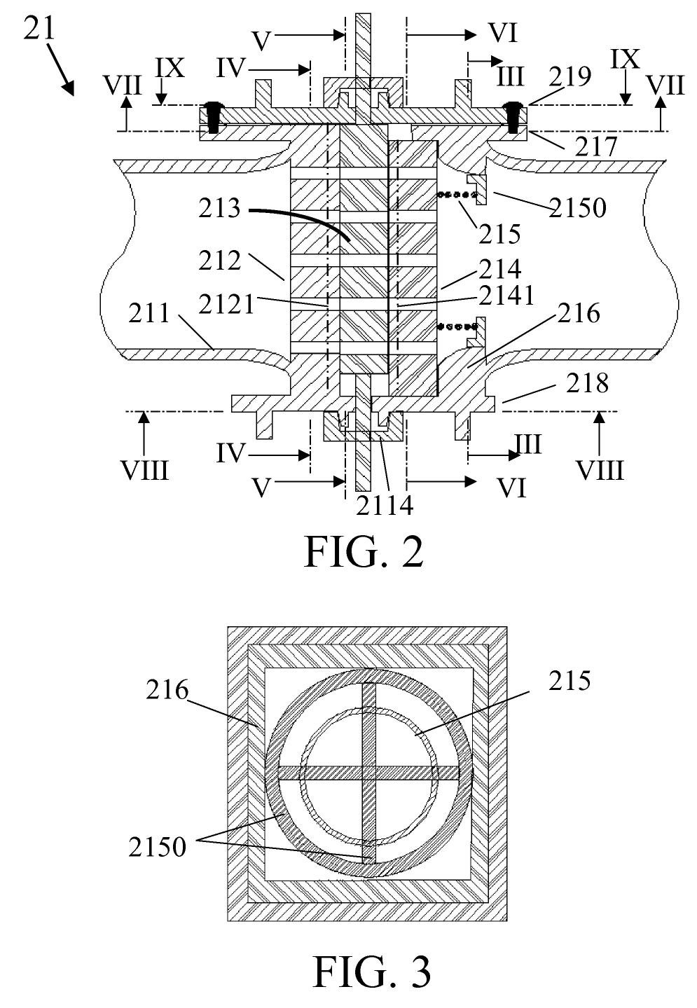

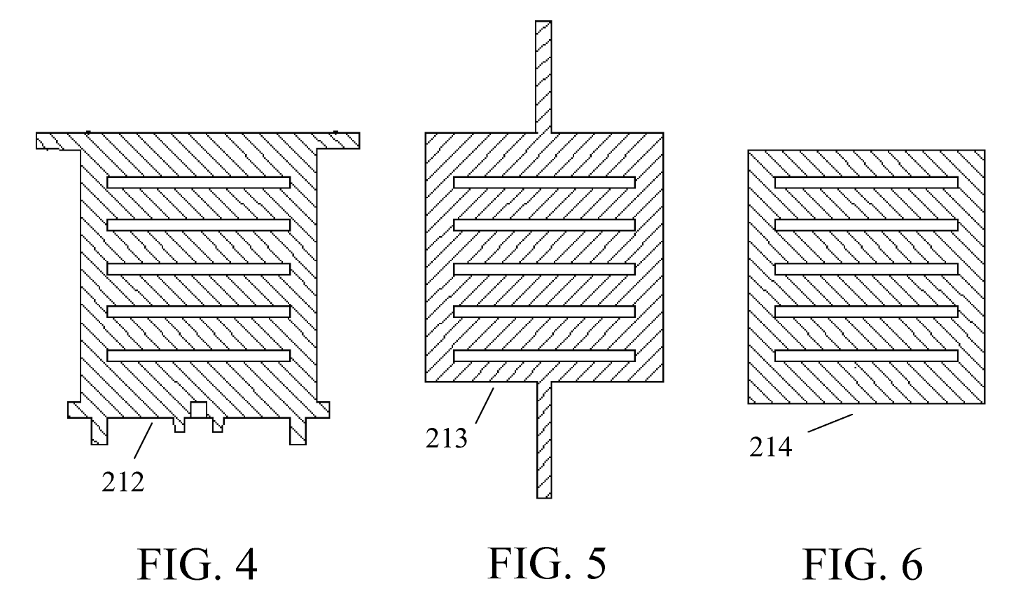

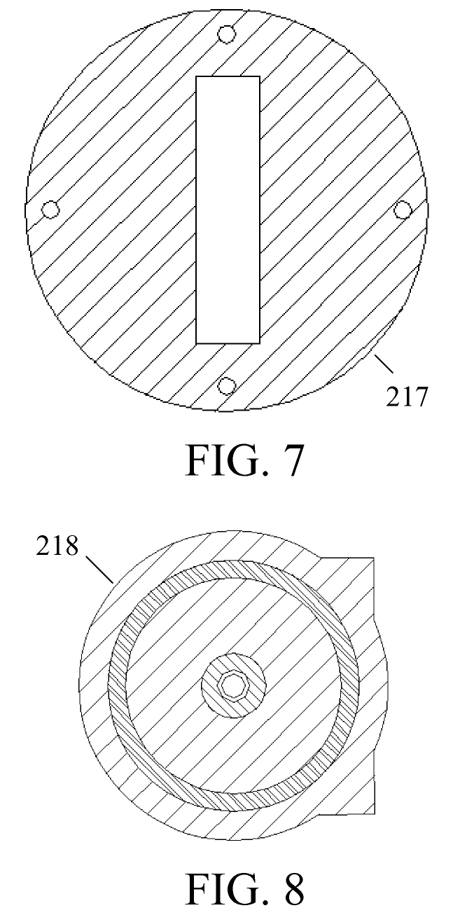

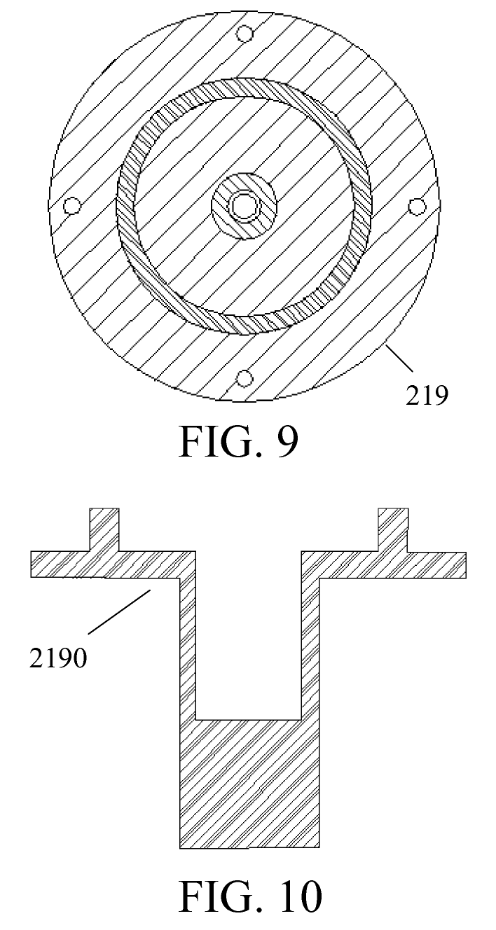

Referring to FIG. 2, the valve body 211, is mirror-symmetrical around the rear surface of the gate plate 213. The end of the valve body 211 starts from a male or female pipe thread fitting (not shown), follows with round cross-section pipe region, and then transitions into an enlarged, squared interior cross-section hub, consisting of items 212, 213, 214, & 216. FIGS. 2 & 4, show that the front borders of the hub is a fixed, front seal plate 212, having a grid pattern on it. The grid pattern has its slots running horizontally, perpendicular to the gate switching direction, up and down. To embrace the movable gate plate 213 within the hub at all times, the wall of the hub corresponding to the front seal plate is extended up and down each end, by a half-length, L, of the grid pattern period, beyond the imaginary valve body limit. This imaginary valve body limit is comparable to the real valve body limit defined on the horizontal direction (valve width). Referring to FIGS. 2 & 5, installed tightly but slide-ably behind the front seal plate is a gate plate 213. This plate is a half-period-length, L, shorter than the inner length of the front seal plate so that it has room to move within the hub region up and down by L. It also has a grid pattern matching that on the front seal plate so that the slots line up when the gate is at its open valve position (shown as all way up, could be all way down). Behind the gate plate is a rear seal plate 214. The size and grid pattern of the rear seal plate are identical to those of the interior portion of the front seal plate. See also FIG. 6 for the shape and relative size of the rear seal plate. FIGS. 4, 5 and 6 are purposely presented on the same sheet to display their relative size. Attention is called to the dash lines on the edges of the seal plates shown is FIG. 2 (2121 and 2141); these lines indicate liner layers are applied to these plates. The rear seal plate is, however, a detachable plate. It is framed in the hub box in such a manner that, it has a movement freedom only in the direction pushing against the gate plate toward the front seal plate, using an implicit or a real spring 215 in holder 2150. This spring load is displayed in FIGS. 2 & 3. Behind the rear seal plate, by its upper and lower ends, the hub has retention walls 216 extended from the valve body wall. These retention walls match the extended external portion of the front seal plate and serve as the frame of the rear seal plate. The spring holder 2150 has a threaded ring to screw onto the retention or valve wall with arms to hold the spring and to provide for pressure adjustment. Both side edges of the hub box are simply closed by the solid valve body walls. The valve body wall is physically merged with the front seal plate and the retention walls. The bottom edge of the hub is otherwise closed except for a gate-maneuver-rod feed-through-hole facing the center of the gate plate bottom edge. The top edge of the hub remains open for the loading of the rear seal, and the gate plates. For the convenience of connecting to a closure component, this top edge and the bottom closure wall are changed from rectangular to circular shape. Depending on the subsequent connection mechanism chosen, the circular plate for the bottom wall could have a smallest possible diameter, with thread fitting ring on it, such as item 218 shown in FIG. 8, which is viewed at line VIII-VIII of FIG. 2 from the bottom. Or it could be a larger than the minimum required diameter circular plate like the flange 217 as shown in FIG. 7 which is viewed from line VII-VII of FIG. 2. Flange 217, converted from the top edge of the hub, spares extra room in the exterior of the valve, for the tying bolts and nuts to go on around the edge of the flange. The choice between these two types of connection is optional as applications fit. Referring to FIG. 9, flange 219, possesses both features of items 217 and 218 on one flange. It converts the item-217-type connection to item-218-type connection. Item 2190 in FIG. 10 is an example of a multiple-function hubcap. Referring back to FIG. 2, beyond the hub region, the valve body 211 is transitioned back to round cross-section and ended in male or female pipe thread fitting. Note that, although the gate driven rod feed through can be seal by cap 2114, a non-moving multiple-function hubcap provides a more positive sealing assurance (Refer to item 2190 in FIG. 1).

For this gate structure, the switching length between fully opened, when the slots in all plates lined up, and securely closed, when the slots on the gate plate aligned with the centers of bars on the seal plates, is half the period of the grid pattern. This is a fraction of that of a conventional valve. It follows that the finer the grid pattern the more the switching length is shortened. However, when the concerns of achieving a positive seal in the closed state, and maximizing the total conduction cross-section in the open state, are considered, there is an optimal choice for each specific application. To ensure a positive seal, the bar width must be greater than the slot width by, at least, two times of a certain width, d. When the slot on the gate plate is positioned against the center of the bar on the seal plates, d is the length of the leak resistance. In a water leak test, d is found to be approximately 0.3 to 0.5 mm. Therefore we will use d=1 mm for this illustration. The finer the grid pattern, the larger the number of this length d, thus the larger portion of the total cross-section, has to be allocated to the blocking side of the formula. Consequently, the percentage of the effective conduction area will drop proportionally. This move conflicts to the desire to maximize the conduction area when the valve is open. In our example, a 1 mm slot width and 3 mm bar width, yields a 21% opening ratio and a 2 mm of required switching length. Remind that the slots have to end, at least, 1 mm away from the edge of the plate. The 21% opening ratio sounds very low; but it is not too far from the 47 to 58% benchmark of a conventional valve, as it also needs to spare for the seal depth provided by the “ring shaped seal wall” mentioned earlier. Two arrangements in this embodiment actually bring the effective conduction area to approach this benchmark. (1) We consolidate the end bars with the extended region of the seal plate and thus improve the ratio to 24.8%. (2) We use a squared internal cross-section hub. This arrangement gains a factor of 4/π resulting in 31.5% if we refer it back to the circular pipe cross-section base. This comparison is based on un-enlarged condition. Moderate enlargement in the hub cross-section may be applied to achieve the desired result.

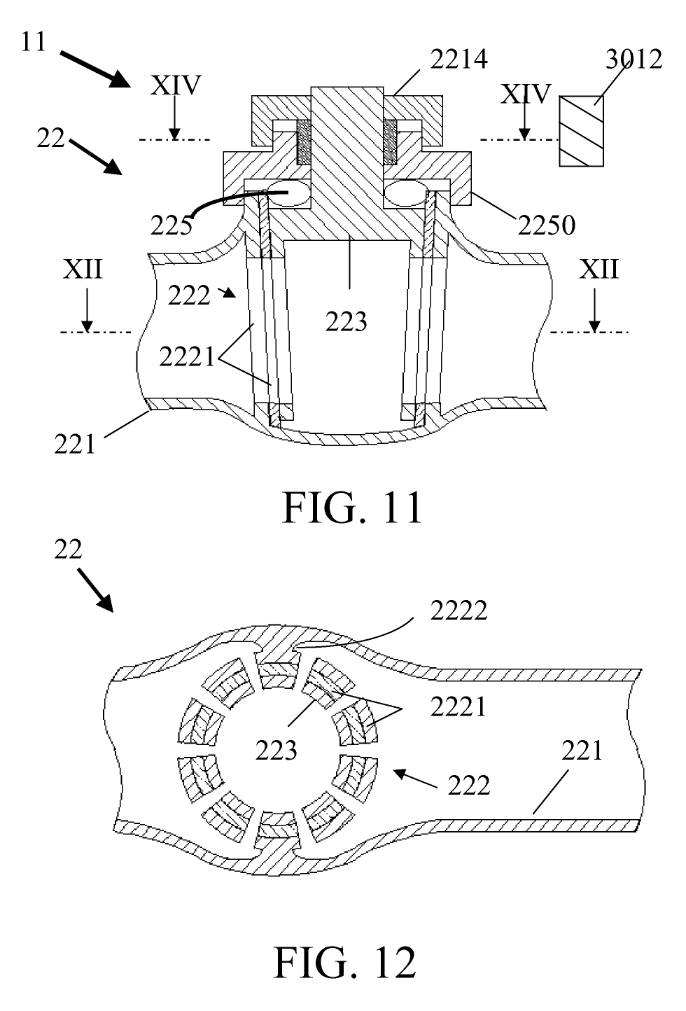

Another embodiment of this invention is directed to the ball type EC valve 11, as jointly shown in FIGS. 11 and 14. For this ball type EC valve, the solenoids, 31 and 32, are externally connected to the switching arm of the valve. FIG. 11 displays mostly the detail of the SSL ball valve 22. FIG. 14 displays mainly the manner of the connection between the solenoids and the valve. The ball type SSL valve body 221 is basically similar to that of the gate type SSL valve 211 except for the hub area. Referring to FIGS. 11 & 12, the hub of the ball type SSL valve 22 doesn't transition into squared shape cross-section. However, it changes from its conventional valve hub as follows. (1) The ball socket holding area is enlarged. (2) The socket shape is changed to a tapered cylindrical shape, 222. (3) A fixed and tapered cylindrical socket wall, including liner, 2221 is built in the socket with the cylindrical axis perpendicular to the valve conducting direction. (4) Grid pattern is built on the wall, with slots running parallel to the rotation axis should the wall was not tapered. The socket wall is connected to the valve body at the socket bottom and further more there are two ear walls 2222 connecting between the tapered cylindrical socket wall and the wall of the valve body in the hub area, if they were not naturally merged, such that the socket together with the ear walls, if applicable, will block the conduction of the valve should the slots in the tapered cylindrical socket wall do not exist. For simplicity, these two ear walls, if used, are placed mirror symmetrically, though not required, between the input and output sides of the valve. In fact asymmetry can be used to manipulate the effective open area ratio.

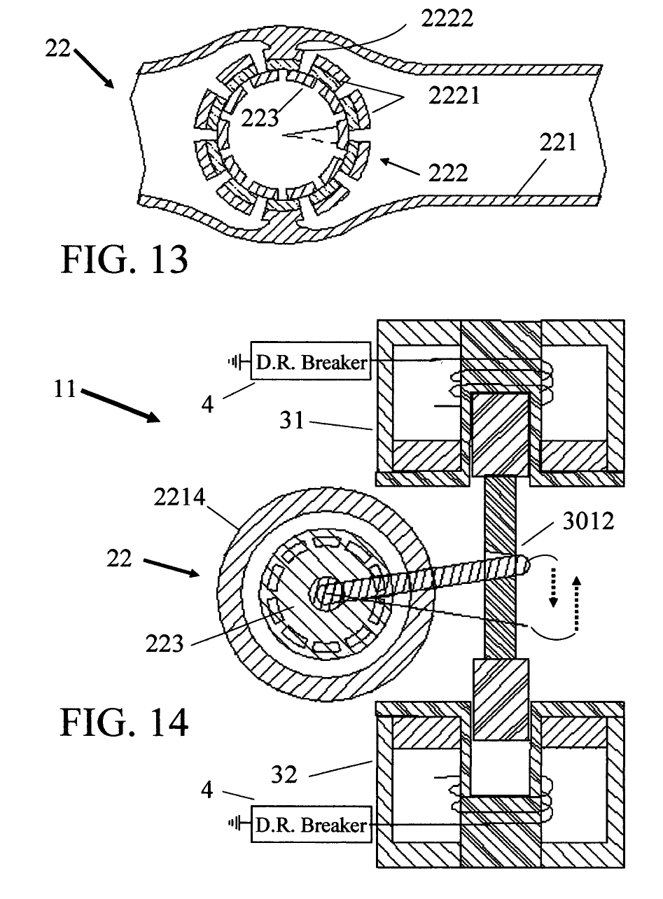

FIG. 11 also shows a conforming tapered cylindrical plug 223. This plug has grid pattern matching that on the socket wall. It can tightly fit into the socket and slide against the tapered cylindrical socket wall 2221 when it rotates. For the same considerations discussed for the gate type SSL valve 21 described in the above paragraph before last, the mean slot width and the bar width are also chosen as 1 mm and 3 mm respectively. In this example the switching angle between the fully opened and securely closed states is 18-degree instead of 90 degrees for a conventional ball valve. FIG. 13 is otherwise identical to FIG. 12 except for that the slots are facing the bars when the plug has been switched an 18-degree to the closed position. A spring load can be added at the top of the plug, under the hubcap 2250, to adjust for the desired pressure tolerance of the valve. A one-inch driving arm turning counterclockwise or clockwise 18-degree is all it needs to open or close the valve. The displacement and its curvature at the arm tip, ¾ inch from the center is small enough such that linear actuators can drive it as shown in FIG. 14.

In this structure, the plug-stem feed-through is not the critical spot for the seal of the valve to the ambient although the seal cap 2214 can provide the seal. The long, upper portion, of the contact surface between the plug and the socket wall plays a major role contributing to a good, secured seal (see the shoulder area in FIG. 11). Therefore, the solenoids are not required to help improving the seal for the valve 22, and can drive the valve at the tip of the driving arm externally to the valve as shown in FIG. 14. According to the test data attached to the end of this description, at a driving point ¾ inches from the rotation center, a solenoid having a stroke length of 6 mm, and pull force of 5 lb impulse, will be able to operate the valve, sparing a safety factor of about 1.15. Test data also show that a small solenoid can work in impulse mode to deliver this level of pull forces. Note that 5 lb at 6 mm stroke is approximately equivalent to 15 lb at 2 mm stroke which is needed for the gate type EC valve. Of course, at the time of production, more precise measurements on the actual valve product to determine the required torque and safety factor should be exercised prior to the final solenoid design.

A genuine short-duty-time solenoid, without over design or incorporating a protector, might not survive many actual situations. Generally, the leaked gas could take a few minutes to clear after the source is shut off. The over heated spot can take even longer time to cool back down below the alarming point. The alarming signal is staying for a while to continue demand energizing the solenoid pointlessly, after the valve has been switched off, and harmfully, risking the destruction of the short-duty solenoid. One needs to prevent the solenoid from being stressed beyond the rated duty time duration. A basic bimetallic strip contact auto circuit breaker is rarely used directly because it trips off upon overload and automatically restores as soon as the contact, not the protected object, cools down. On the other hand, its commercial version has a latch mechanism to hold the off state until manual reset. The safety system may be invalidated if one forgets to reset. This invention describes a method, not only defines the condition for the circuit to trip off, but also controls/prolongs the delay of contact restoring time of the circuit breaker using low cost elements. Briefly, a bimetallic contact strip in series with a resister, are packaged together in a thermal insulation tube.

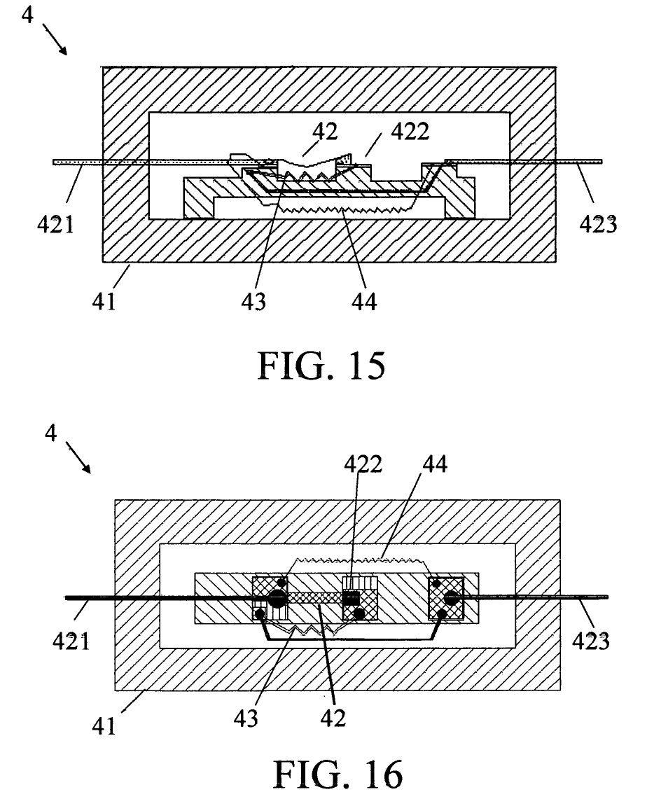

FIGS. 15 and 16 are respectively the side and top schematic sectional views of a preferred embodiment of the delayed-restoring automatic circuit breaker 4. It includes an electrical insulating mounting base in a thermal insulation shell 41, a bimetallic strip contact switch 42, in series with a low value resister 43, and a high value parallel resister 44. The bimetallic strip of the contact switch has one end soldered to an external lead 421 and the other end touching the contact pad 422. The solder point is fixed on one end and the contact pad 422 is deposited on the other end of the mounting base. Resister 43 is electrically connected between pad 422 and external lead 423. This resister is arranged to route through pad 421 such that it is installed side by side with the bimetallic strip. Note that the resister 43 has no direct electrical connection with the external wire 421 except through the bimetallic strip. The strip is configured such that at ambient temperatures, the strip has certain moderate pressure pushing against the contact pad 422 and it curves up and disconnected from the contact pad at a predetermined temperature above the ambient temperature. The heat generated on the strip itself brings the strip close to, but not enough to reach, the curve up temperature. More heat radiates on the strip, from the series resister 43 and possibly the parallel resister 44, for a predetermined time period, say one second, causes the strip to curve-up and disconnect from the contact pad. This arrangement delays the trip off time to ensure the activation of the solenoid. Heat generated on the series resister results in a temperature higher than the bimetallic strip curve-up temperature and transfers heat to the strip through radiation. This overshoot phenomenon is one of the factors used to prolong the restoring delay time. High value resister 44, connected between leads 421 and 423, is optional for adjusting the cut off and restoring timing by affecting the thermal budget of the insulation package 41.

The approximate value of each element in the delayed-restoring automatic circuit breaker can be estimated as follows. The specific heat coefficient of a material is generally a function of temperature. For the simplicity of a conceptual description, let us assume that it is a constant C_{P} over a small temperature range of concern, ΔT. Let us further assume that the weight of the bimetallic strip is w; the strip resistance, including contact, is R_{C}; and the average current the solenoid drains for the intended application, in the time period t, is I, the parallel resistance is R_{P}. Then the series resistance value R_{S} is:

R_{S}=(wCₚΔT)/(I²t)−R_{C}; where C_{P}=˜2.7 j/° C./g, ΔT=˜4° C., I=1.2 amp, and t=1 Sec.

This equation is derived from the following relations. The total heat energy E, generated due to the electrical current passing through the circuit breaker, is equal to the energy required to raise ΔT in the strip, such that E=I²(R_{S}+R_{C})t=wC_{P}ΔT. This is a highly simplified model, but is a good approximation. We have ignored the thermal loss to the air and the heat generation from the R_{P}, which are attentively off set each other. Note that overshoot condition, which will demand higher R_{S}, has not applied in this simplified case. Thus exact values cannot be determined until the insulating package is characterized and elements arrangement is determined.

This principle can be widely applied and each application requires its own specific optimization. For our current application, we need only to handle current estimated around one ampere. Therefore the bimetallic strip should be small, say below 0.5 gram. The optimal arrangement of the bimetallic strip and the heating resister can be determined mathematically or empirically, an easier route. Too close to each other reduces the amount of heat overshoot and too far apart losses the heater's influence resulting in the need of a higher value series resister than necessary. For an efficient operation, the low value series resister should not exceed 4 ohms in our present case. The parallel connected, high value resister 44, in mega ohm range, is used to beef up the delay mechanism by making up energy loss due to inadequacy in thermal insulation.

### Test Data and Reference Information

### 1. Test Data

Pull tests on conventional gas valves revealed the following data: It takes about 2.5 pounds, at a location 1 inch away from the rotation center, to start moving the switch arm. For a ½ inch ball valve, first order estimate of the friction resistance force is about 12.733 pounds at the sliding surface. Adding a 1.15 safety factor, a ½ inch gas valve can be driven by solenoids capable of deliver 15 lb impulse pull force at 2 mm stroke length or 5 lb impulse pull force at 6 mm stroke length within time periods less than 1 second.

A 24 volt AC, low cost sprinkle solenoid was evaluated for its impulse handling potential. This test proves that by using the solenoid in the proposed impulse mode, its pulling capability can conservatively raise 20 folds. Its stroke length is 12 mm with an initial pull force of 2.5 ounces (oz) for controlling the anti-siphon sprinkle valve. When the plunger is held at 2 mm away from the end position, the initial pull force increases to 15 oz. At the same 2 mm stroke length, when energized by a 45-volt AC pulse for a split second, it instantly pulls up a 3 pounds (lb) weight. It survived stresses of 72-volt AC pulses of 1 to 2 seconds duration repeatedly at 5 seconds to several minutes apart.

### 2. Reference Information

A solenoid customized from the tested sample is reasonably expected not only to beef up its pulling power but also to simplify the assembly. The customizations may include terms such as: (1) reduces the number of turns of the coil (e.g. from 600 to 240) to bring it down to low voltage region (say <48 volts) and to minimize its physical size, (2) increases the coil wire size (e.g. from gauge 33 to 22), so that it properly increases the current rating of the solenoid and (3) consolidates the functions of mounting plate of the solenoid with the plunger housing and the valve hubcap. It is easily understood that none of these customizations demands a more sophisticated technology than that used for the sprinkle solenoid. Only the design is changed based on the product needs.

The on-line (www dot futurlec dot com) price for a 5-volt natural gas sensor is $6.90.

I claim:

1) A shortened switching length gate valve, comprising:
a valve body having a fixed front seal plate at the front border of the valve hub, in the conduction path region, not parallel or simply perpendicular to the valve conduction path so that the said seal plate could block the valve conduction should no slots were built on the plate; and having a fixed rear seal plate at the rear border of the valve hub, parallel to the front seal plate; where each said seal plate has an identical grid pattern conforming to the shape of the plate with slot surrounded by sufficient blocking area, or the said rear seal plate could just have a big hole; and
a separate gate plate, having a grid pattern identical to that on the front seal plate, tightly fit between the front and rear seal plates, and slide-able with respect to the seal plates in the direction far from parallel and preferably perpendicular to the grid slot length for a distance (≧half grid period) enough to switch the valve between fully opened and securely closed.

2) The shortened switching length gate valve claimed in claim (1), wherein the seal and gate plates have curved shapes continued supporting the linear displacement gate switching, perpendicular to the grid slots.

3) The shortened switching length gate valve claimed in claim (1), wherein the rear seal plate is a detachable plate, being framed in the hub with movement freedom only allowed in the direction pushing against the gate plate toward the front seal plate, using a spring load.

4) A shortened switching angle ball valve, comprising:
a valve body having a fixed, slightly tapered cylindrical socket wall in the conduction path region with the cylindrical axis not parallel and preferably perpendicular to the valve conduction direction, so that the said socket wall could block the valve conduction should the wall stayed solid, and having grid pattern with slots on the tapered cylindrical wall running far from perpendicular to the cylindrical axis, usually parallel to the cylindrical axis should the cylindrical wall is not tapered;
a conforming tapered cylindrical plug, having an identical grid pattern, tightly fit and slide-able co-axially with respect to the socket wall when the plug rotates; and
an adjustable spring, explicit or implicit, loading on top of the plug, pressing the plug tightly into the conforming tapered cylindrical socket wall.

5) The shortened switching angle ball valve claimed in claim (4), wherein the socket and plug has other shapes continued supporting rotational switching.

6) A time delayed recovery, automatic circuit breaker, comprising:
an electrical insulating mounting base within a thermal insulation shell;
a bimetallic strip contact switch, having one end tied to an external lead fixed on one end of the mounting base and the other end touching the contact pad deposited on the other end of the mounting base, configured such that, at ambient temperatures, the strip is having certain moderate pressure firmly pushing against the contact pad and tripping off the contact pad when enough radiations from both or either of the following resisters are received;
a low value series resister, connected between the contact pad and another external lead, arranged side by side with the said bimetallic strip, having resistance value low enough not to adversely affect the function of the device to be protected but high enough to generate the required heat; and
a high value parallel resister, connected between the two external leads, having resistance value above mega ohms so that the maintaining current is negligible for the system to bear while making up the required thermal budget balance in case of thermal insulation deficiency.
Either the low value resister may include values near zero (simple lead) or the high value resister may include values near infinite (open circuit), but not both reaching the extremes in a same case.

7) A gate type Easy-Control Valve, comprising:
a shortened switching length gate valve claimed in claim (3); driven by
two solenoids, positioned in top and bottom sides of the valve hub, one for opening and the other for closing the subject valve, wherein their mounting plates also serve as the ultimate seal for the valve; and each solenoid is protected by
a time delayed recovery automatic circuit breaker claimed in claim (6) so that the solenoids can be much reduced in size as for a true low duty time impulse type.

8) A ball type Easy-Control Valve, comprising:
a shortened switching angle ball valve claimed in claim (4); driven by
two solenoids, positioned in opposite sides of the switching arm, one for opening and the other for closing the subject valve; and each solenoid is protected by
a time delayed recovery automatic circuit breaker claimed in claim (6) so that the solenoids can be much reduced in size as for a true low duty time impulse type.
